(19) United States
(12) Patent Application Publication
(10) Pub. No.: US 2004/0096078 A1
(43) Pub. Date: May 20, 2004

(54) Information display device assembled with spectacle frame

(76) Inventor: Titan Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/294,726

(22) Filed: Nov. 15, 2002

(51) Int. Cl. H04R 25/00; H04R 1/02; H04R 9/06

(52) U.S. Cl. 381/333; 381/327; 381/381

(57) ABSTRACT

An information display device is assembled with at least one temple of a spectacle frame. The information display device includes a circuit and a speaker located close to a user's ear. The circuit is connected to the speaker via a wire. The information display device converts the electromagnetic wave from the base station to a direct current that make the speaker sound. Since the information display device is arranged inside the temple of the spectacle frame close to the user's ear, the user is quickly alerted of an incoming telephone call.

### BACKGROUND OF THE INVENTION

1. Field of the Invention

The present invention relates to an information display device that is assembled with a spectacle frame. More specifically, the present invention provides an information display device that, assembled with a spectacle frame, includes a speaker located close to the user's ear so that the user is alerted of any incoming telephone call even in a noisy environment or when he/she wears a helmet.

2. Description of the Related Art

Referring to FIG. 1, a conventional information display window 11 includes a circuit 12 and a light emitting element 13. The circuit 12 is mounted inside a cell phone 14 and is connected to the light emitting element 13. The light emitting element 13 is mounted inside a transparent antenna 15 of the cell phone 14. When there is an incoming telephone call, the circuit 12 drives the light emitting element 13 to flash while the cell phone rings. However, in a noisy environment or when the user wears a helmet, it is difficult for the user to be alerted of an incoming telephone call.

### SUMMARY OF THE INVENTION

It is one object of the invention to provide an information display device that is assembled with a spectacle frame. The information display device has a speaker located close to the user's ear so that he/she is alerted of any incoming telephone calls even in noisy environments or when he/she wears a helmet.

It is another object of the invention to provide an information display device assembled with a spectacle frame that further includes a light emitting element located within an effective field of view. Therefore, when there is an incoming telephone call, not only the speaker sounds, but the light emitting element also flashes to alert the user of the incoming telephone call.

To achieve the above and other objectives, an information display device of the invention is assembled with at least one temple of a spectacle frame. The information display device includes a circuit and a speaker located close to the user's ear. The circuit is connected to the speaker via a wire.

### BRIEF DESCRIPTION OF THE DRAWINGS

The drawings included herein provide a further understanding of the invention and, incorporated herein, constitute a part of the invention disclosure. A brief introduction of the drawings is as follows:

FIG. 1 is a perspective view of a conventional information display device mounted to a cell phone;

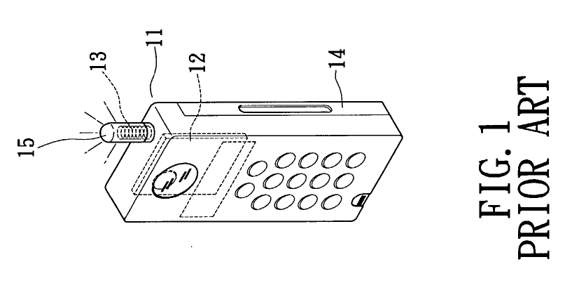

FIG. 2 is a perspective view of an information display device according to one embodiment of the invention;

FIG. 3 is a schematic view showing the use of an information display device according to one embodiment of the invention; and

FIG. 4 is a schematic view showing the use of an information display device according to another embodiment of the invention.

### DESCRIPTION OF THE PREFERRED EMBODIMENTS

The following detailed description of the invention with reference to the accompanying drawings is only illustrative of specific structures and ways of making the invention, and does not limit the scope of the invention. Wherever possible in the description, like reference numerals will refer to like elements and parts unless otherwise illustrated.

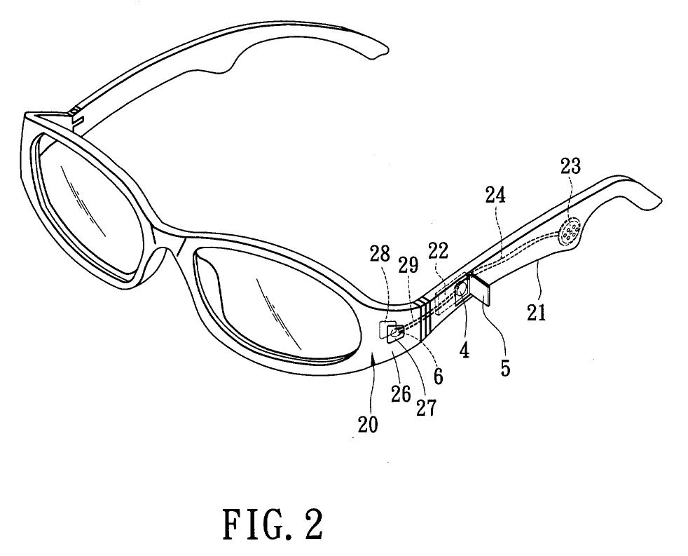

FIG. 2 is a perspective view of a spectacle frame assembly with an information display device thereon. The spectacle frame assembly includes a spectacle frame 20 and an information display device. The spectacle frame 20 can be any type of spectacle frame such as presbyopic glasses or sunglasses with wide temples. The information display device is arranged inside one of the temples 21 of the spectacle frame 20. The information display device includes a circuit 22 and a speaker 23. The circuit 22 is connected to the speaker 23 via a wire 24.

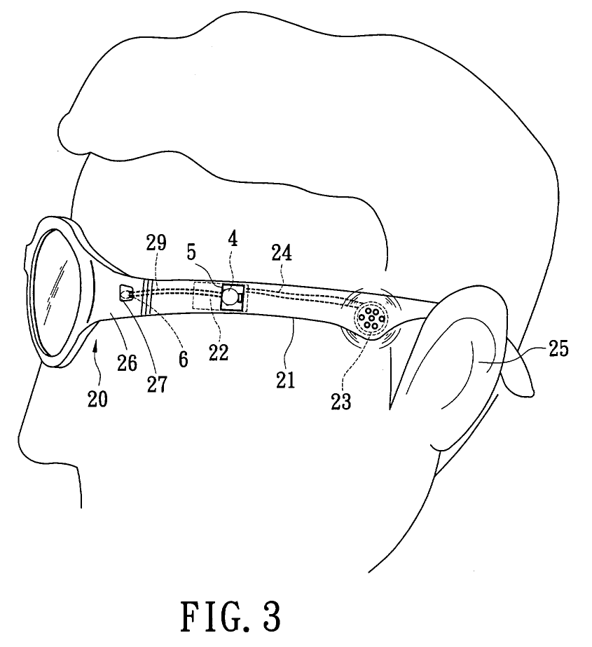

Referring to FIG. 3, a testing electromagnetic wave is typically sent to a cell phone 14 from a base station before a data signal is transmitted to the cell phone 14. After the cell phone 14 has received the testing electromagnetic wave, a confirmation signal is sent back from the cell phone 14. Only after the base station has received the confirmation signal, the data signal is transmitted to the cell phone 14. The confirmation signal from the cell phone 14 is received and converted by the information display device of the invention to a direct current. This is preferably accomplished at an adequate distance, for example, 0.5 m from the cell phone 14, to avoid the interference of undesired electromagnetic waves. The direct current is transmitted to the speaker 23 through the wire 24 to emit sound. Since the speaker 23 is arranged inside one temple 21 of the spectacle frame 20 close to the user's ear, the user is thereby quickly alerted of the incoming telephone call.

Referring to FIG. 2 and FIG. 3, a bent joint 26 is provided between a spectacle lens and the temple 21. A light emitting element 6 can be further provided inside the bent joint 26. A front transparent window 27 and a rear transparent window 28 are respectively embedded in the bent joint 26 so that the user can see from either side the light from the light emitting element 6. The light emitting element 6 is connected to the circuit 22 via a wire 29. Furthermore, the bent joint 6 is located within an effective field of view. Therefore, when there is an incoming telephone call, not only the speaker 23 sounds, but the light emitting element 6 also flashes. The user thereby is alerted of the incoming telephone call by hearing the sound emitted by the speaker and by viewing through the transparent windows.

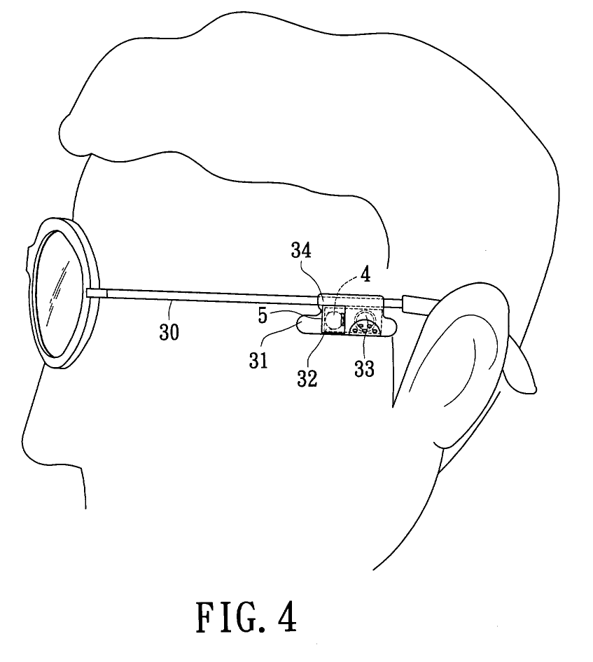

Referring to FIG. 4, an information display device 31 according to another embodiment includes a circuit 32 and a speaker integrally formed with the circuit 32. The information display device 31 is further provided with a hook 34 that clips one temple of a spectacle frame. Therefore, the information display device 34 can be easily detached from the spectacle frame. The information display device of this embodiment is therefore particularly suitable for spectacles with narrow temples.

With reference to FIG. 2, FIG. 3 and FIG. 4, batteries 4 are respectively provided to supply power to the circuits 22 and 32. Covers 5 are mounted on the temples 21, 30 at a location corresponding to the batteries 4.

As described above, the invention therefore has the following advantages.

(1) The information display device can be arranged inside the temple of the spectacle frame, which allows a more esthetic aspect.

(2) The speaker is located close to the user's ear. Therefore, the user can be easily alerted of any incoming telephone call even if he/she is in a noisy environment or wears a helmet.

(3) The light emitting element is located inside the effective field of view. Therefore, the user can be alerted of an incoming telephone call by hearing the sound emitted by the speaker and by viewing through the transparent windows.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An information display device assembled with at least one temple of a spectacle frame, the information display device comprising:
a circuit; and
a speaker located close to a user's ear, wherein the circuit is connected to the speaker via a wire.

2. The information display device of claim 1, wherein the circuit and the speaker are formed in a single body, and are detachable from the spectacle frame.

3. The information display device of claim 2, wherein the information display device is further provided with a hook that clips the temple of the spectacle frame.

4. The information display device of claim 1, wherein a bent joint is located between a spectacle lens and the temple within an effective field of view of the user, a light emitting element being further provided inside the bent joint, and a front transparent window and a rear transparent window being respectively embedded in the bent joint so that the user is able to see from either sides the light from the light emitting element.

5. The information display device of claim 1, wherein the circuit and the speaker are formed inside the temple of the spectacle frame.
